(19) United States
(12) Patent Application Publication
(10) Pub. No.: US 2008/0314316 A1
(43) Pub. Date: Dec. 25, 2008

(54) MONITORING SYSTEM AND MONITORING METHOD FOR SUBSTRATE PRODUCTION APPARATUS

(76) Inventor: Masaki Kitabata, Toyama (JP)

Correspondence Address: MCDERMOTT WILL & EMERY LLP, 600 13TH STREET, NW, WASHINGTON, DC, 20005-3096, US

(21) Appl. No.: 12/141,508

(22) Filed: Jun. 18, 2008

(30) Foreign Application Priority Data
Jun. 20, 2007 (JP) 2007-162383

(51) Int. Cl. B05C 11/00

(52) U.S. Cl. 118/712

(57) ABSTRACT

The substrate production apparatus monitoring system of the present invention comprises a data collection unit, a data storage unit, a control state identification unit, and a data evaluation unit. The data collection unit collects control parameter data from the substrate production apparatus including a subsidiary equipment. The control parameter data collected by the data collection unit are stored in the data storage unit. The control state identification unit identifies the control state of the substrate production apparatus based on the data in the data storage unit. The data evaluation unit evaluates the identified, individual control state as to whether it is abnormal/normal. In this way, any abnormal event in the apparatus even in the idle mode can be detected prior to the substrate processing, preventing reduction in the production yield.

### CROSS-REFERENCE TO RELATED APPLICATION

The present application claims the benefit of Japanese Patent Application No. 2007-162383 filed Jun. 20, 2007, the subject matter of which is incorporated herein by reference.

### BACKGROUND OF THE INVENTION

1. Field of the Invention

The present invention relates to a monitoring system and monitoring method for a substrate production apparatus and particularly to a monitoring system and monitoring method for a substrate production apparatus including subsidiary equipment.

2. Description of the Related Art

Substrate devices such as semiconductor devices are more highly integrated and substrate production steps have been increased in number and become more complex in process operation. The production yield of substrate devices is determined on the premises that the substrate production apparatus operates normally. When the apparatus does not operate normally and fails to execute substrate processing within the normal range, the apparatus state is one of the determinant factors of the production yield. If defects occur because of the substrate production apparatus, it becomes necessary to investigate the cause and to find countermeasures.

In the prior art substrate production apparatus monitoring, various apparatus parameters are monitored. Here, the apparatus parameters are parameters obtained from the substrate production apparatus, including (a) “control parameters” such as flow rates and temperatures controlled by the recipe; (b) “context parameters” indicating IDs unique to wafers such as wafer lot names and recipe names; (c) “processing state parameters” indicating processing states such as recipe step numbers, processing states indicating the apparatus states such as in the operation mode and in the idle mode, and chemical solution lifetime (operation time since the introduction of chemical solution); and (d) “analog parameters” such as voltages and currents directly obtained from measuring instrument of the production apparatus and subsidiary equipments.

When the substrate production apparatus processes substrates, necessary data among the above apparatus parameters should be collected in real time. Recently, the apparatus parameters are electrically monitored as disclosed in the Japanese Laid-Open Patent Publication Nos. H10-106916 and 2004-319857. In such a way, the substrate production apparatus can be monitored continuously over a prolonged time period Then, quick response to fluctuations or changes with time in apparatus parameters of the substrate production apparatus can be made.

FIG. 7 is a schematic diagram showing a prior art substrate production apparatus. This substrate production apparatus supplies a chemical solution to process substrates placed in a reaction process chamber.

In FIG. 7, a substrate production apparatus 101 comprises a reaction process chamber 102. A chemical cabinet (subsidiary equipment) 107 for preparing a chemical solution and controlling the concentration/temperature of the chemical solution and a vacuum pump 109 for vacuuming the reaction process chamber are connected to the reaction process chamber 102. The substrate production apparatus 101 is provided with sensors 103, 104, and 105 in places for measuring control parameters such as the pressure and temperature in the substrate production apparatus 101. The chemical cabinet 107 is provided with a sensor 108 for measuring control parameters such as the chemical solution flow rate. Furthermore, the substrate production apparatus 101 is provided with a control computer 106 controlling the operation of the substrate production apparatus 101 and chemical cabinet 107 based on the control parameters measured by the sensors.

Furthermore, a monitoring system 111 monitoring the substrate production apparatus 101 and chemical cabinet 107 is connected to the substrate production apparatus 101. The monitoring system 111 comprises a selector switch (also termed a bypass switch) 112, a data collection unit 113, a data storage unit 115, and a data evaluation unit 114. A host computer 110 is connected to the selector switch 112.

In the above configuration, substrates are transferred to the reaction process chamber 102 and subject to a predetermined process. During processing, sensors 103 to 105 are controlled for set values determined according to the process recipe stored in the control computer 106 or automatically controlled for such set values. Therefore, measurements of the sensors fluctuate and data from the sensors 103 to 105 are sent to the control computer 106. The chemical cabinet 107 similarly receives control instructions from the substrate production apparatus 101 (the control computer 106). The chemical cabinet 107 operates according to the control instructions and sends data from the sensor 108 to the control computer 106. Here, the data from the sensors is collected by the data collection unit 113 of the monitoring system 111 in a specified sampling cycle and stored in the data storage unit 115.

Instructions such as production process recipe download, substrate process start, and end report are given by the host computer 110 connected to the control computer 106 via the selector switch 112. The selector switch 112 switches over between the state in which the control computer 106 and host computer 110 are communicable and the state in which the control computer 106 and data collection unit 113 are communicable.

FIG. 8 is a graphical representation showing chronological changes in a control parameter collected by the monitoring system in a prior art substrate production apparatus. FIG. 8 shows the flow rate waveform of a chemical flowmeter. In FIG. 8, the horizontal axis corresponds to time. The sections 81, 82, 83, and 84 are the time frames in which four processing steps A to D in the recipe are performed. When the processing steps are performed in sequence, the chemical solution flow rate fluctuates according to the processing step. The dash-dot lines 85 in FIG. 8 indicate the upper (upper flow rate) thresholds of the fluctuation range during the normal operation. Similarly, the broken lines 86 in FIG. 8 indicate the lower (lower flow rate) thresholds of the fluctuation range during the normal operation. The upper and lower thresholds are determined for each processing step of the recipe according to processing conditions. When the flow rate outranges the thresholds, the substrate production apparatus is presumed to be in an abnormal state. The above technique makes it possible that signals such as alarms are issued to the operator or the substrate production apparatus automatically stops operating when the substrate production apparatus becomes unstable because of apparatus problems and the like. Consequently, serious loss as a result of reduction in the production yield can be prevented,

### SUMMARY OF THE INVENTION

However, the above described substrate production apparatus has the following problems.

Generally, the substrate production apparatus is either in the substrate processing mode (operation mode) or in the non-processing, idle mode. When it is in the non-processing, idle mode, the substrate production apparatus is either in a standby mode in which the apparatus is simply not in operation and on standby so that it can immediately start processing substrates or in a stable-state waiting mode in which the apparatus waits for some control parameter (for example the temperature of the reaction process chamber) being stabilized prior to the substrate processing. There are two major reasons that the apparatus shifts to the stable-state waiting mode, as explained hereafter using a substrate cleaning apparatus.

The first reason is that production lines producing many different products have multiple processing recipes of different conditions (processing conditions) and, if a different recipe is used in the preceding substrate processing, the substrate processing does not start until all control parameters comply with the current processing recipe conditions. Such control parameters include temperatures and concentrations that are difficult to reach the set values of the processing recipe in a moment.

The second reason is that the substrate processing starts after individual controls in the subsidiary equipments of the substrate cleaning apparatus are completed. More specifically, for example, the substrate cleaning apparatus instructs the chemical cabinet supplying a chemical solution to the substrate cleaning apparatus to replace the chemical solution after specific conditions are satisfied and, then, various controls over the chemical solution in a tank of the chemical cabinet such as discharge, supply, and temperature adjustment are conducted. These controls are conducted while the substrate cleaning apparatus is in the idle mode. While this series of controls are conducted, the chemical cabinet cannot supply the chemical solution to the substrate cleaning apparatus. Therefore, the substrate cleaning processing does not start. The controls on the chemical solution replacement are conducted in the chemical cabinet independently of the substrate cleaning apparatus. When the chemical solution replacement is completed, the substrate cleaning apparatus is informed of the completion.

FIG. 9 is a graphical representation showing a relationship between the chemical solution temperature and a elapsed time of control states of the cleaning apparatus around the chemical solution replacement. In FIG. 9, the left vertical axis corresponds to the temperature, the right vertical axis corresponds to the elapsed time from the start of each state, and the horizontal axis corresponds to time. In FIG. 9, the chemical solution temperature is presented by solid line and the elapsed time is presented by dotted line. In FIG. 9, the substrate cleaning apparatus is in the idle mode in a section 91, in the middle of chemical solution replacement in a section 92, and in the substrate processing mode in a section 93.

The chemical cabinet does not inform the substrate cleaning apparatus of control events in the subsidiary equipment such as discharge, supply, and temperature adjustment. The substrate cleaning apparatus knows brief controls conducted in the chemical cabinet in order to give instructions such as chemical solution replacement. However, it does not know detailed controls in the subsidiary equipment such as discharge, supply, and temperature adjustment during the chemical solution replacement. Therefore, any abnormal event in each control state cannot be noticed and it is difficult to detect any abnormal event in the subsidiary equipment.

In other words, the prior art monitoring system does not monitor the states of control parameters while the substrate production apparatus is in the idle mode and, consequently, the substrate processing apparatus is found to be in an abnormal state after the substrate processing starts, leading to possible reduction in the production yield.

This problem can be resolved by connecting the prior art monitoring system directly to the subsidiary equipment. However, in general, multiple subsidiary equipments are connected to the substrate production apparatus. Connecting to all of them is costly and impractical.

Then, the purpose of the present invention is to provide a monitoring system and monitoring method comprising a means for obtaining apparatus parameter of a substrate production apparatus and subsidiary equipment and a means for identifying the control state of the subsidiary equipment based on the obtained apparatus parameter, wherein the identified, individual control state of the subsidiary equipment is evaluated as to whether or not there is any abnormal control parameter value so that any abnormal event in the substrate production apparatus including the subsidiary equipment can be detected in an early stage.

In order to accomplish the objective, the present invention has adopted technical means mentioned below. At first, the present invention is premised upon a monitoring system for a substrate production apparatus including a subsidiary equipment in which a predetermined reaction process takes place in a reaction chamber where a substrate is placed. In the monitoring system of the present invention, a data collection unit collects control parameter data from the substrate production apparatus in a specific sampling cycle. The control parameter data collected by the data collection unit are stored in a data storage unit. A control state identification unit identifies control states of the substrate production apparatus including the subsidiary equipment based on the obtained control parameter data stored in the data storage unit. A data evaluation unit evaluates the identified, individual control state as to whether or not there is any abnormal event. In the monitoring system of the present invention having the above configuration, the control states in a substrate processing mode and in an idle mode of the substrate production apparatus including the subsidiary equipment is identified based on the obtained control parameter data and the individual control state is evaluated as to whether or not there is any abnormal control parameter.

With the above configuration, the substrate production apparatus can know the individual control state in the idle mode. With the individual control state being known, the individual control state can be evaluated as to whether it is abnormal/normal (abnormal or normal).

The above monitoring system may further comprise an analog parameter collection unit obtaining an analog parameter including a control voltage of a controlled part provided in the subsidiary equipment and converting analog data to digital data (analog/digital conversion).

The analog parameter such as control voltage of the controlled part provided in the subsidiary equipment can be anything presenting a control state of the subsidiary equipment, including a control voltage of an electromagnetic valve on the chemical solution line and an output voltage of a level sensor detecting the content of a chemical solution tank. These data do not need to be obtained if they are available via the control computer of the substrate production apparatus.

On the other hand, in another aspect, the present invention provides a monitoring method for a substrate production apparatus including a subsidiary equipment in which a predetermined reaction process takes place in a reaction chamber where a substrate is placed. In the monitoring method of the present invention, first, control parameter data from the substrate production apparatus are collected in a specific sampling cycle. The collected control parameter data are stored in a data storage unit. The control state of the substrate production apparatus including the subsidiary equipment is identified based on the data stored in the data storage unit. The identified, individual control state is evaluated as to whether or not there is any abnormal event. Thus, control states in a substrate processing mode and in an idle mode of the substrate production apparatus including subsidiary equipments is identified based on the obtained control parameter data and the individual control state is evaluated as to whether or not there is any abnormal control parameter.

With the above method, the substrate production apparatus can know the individual control state in the idle mode. With the individual control state being known, the individual control state can be evaluated as to whether it is abnormal/normal. In this way, it can be determined whether the subsidiary equipment and substrate production apparatus are abnormal/normal prior to the substrate processing while abnormal control parameters can only be detected when they are controlled by the recipe during the substrate processing in the prior art, preventing a reduction in the production yield.

In the present invention, abnormal events in the substrate production apparatus can be detected in advance, improving the production yield.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a schematic diagram showing a configuration of a substrate production apparatus according to an embodiment of the present invention.

FIG. 2 is a schematic diagram showing a modified configuration of a substrate production apparatus according to an embodiment of the present invention.

FIG. 3 is a flowchart of identifying a chemical cabinet control state according to an embodiment of the present invention.

FIG. 4 is a graphical representation showing control state identification results according to an embodiment of the present invention.

FIG. 5 is a flowchart of identifying a state of the substrate production apparatus according to an embodiment of the present invention.

FIG. 6 is a graphical representation showing a trend of temperature adjustment time during the chemical solution replacement according to an embodiment of the present invention.

FIG. 7 is a schematic diagram showing a prior art substrate production apparatus.

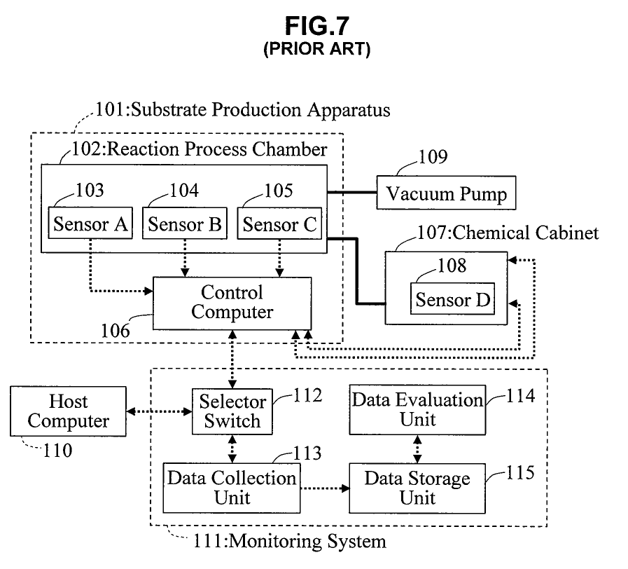

FIG. 8 is a graphical representation showing chronological changes in a chemical solution flow rate in a prior art substrate production apparatus.

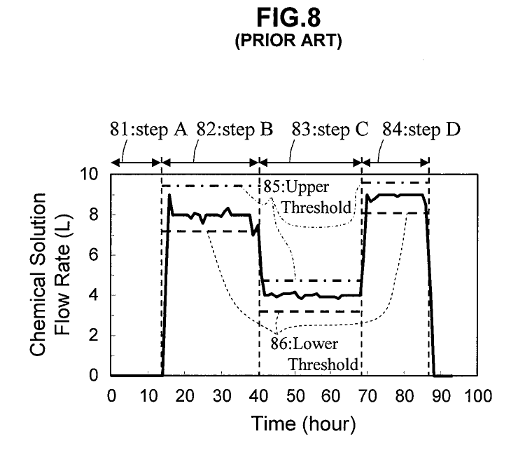

FIG. 9 is a graphical representation showing chronological changes in a temperature during a idle mode of a prior art substrate production apparatus.

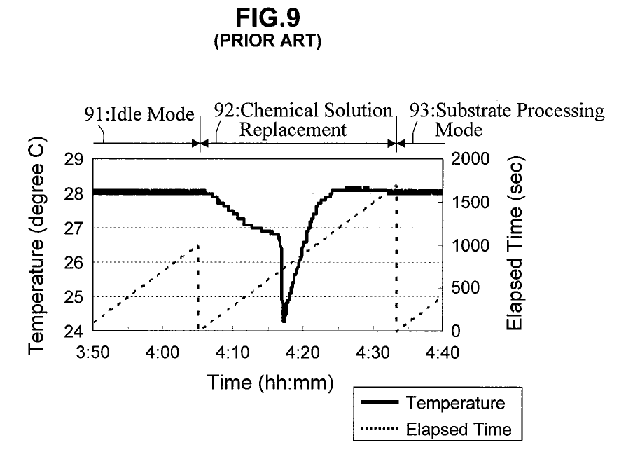

### DETAILED DESCRIPTION OF PREFERRED EMBODIMENTS

An embodiment of the present invention is described in detail hereafter, with reference to the drawings.

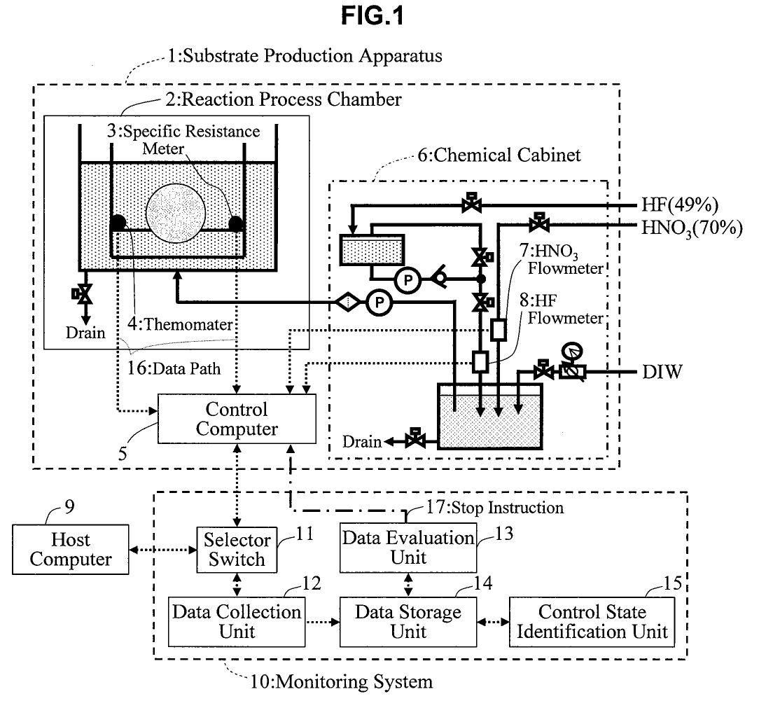

FIG. 1 is a schematic diagram showing a configuration of a substrate production apparatus according to this embodiment. The substrate production apparatus is an apparatus in which a chemical solution is supplied to process a substrate placed in a reaction process chamber. Here, the reaction process chamber and a chemical cabinet, which is a subsidiary equipment, are collectively termed the substrate processing apparatus.

In a substrate production apparatus 1 of this embodiment, a substrate is transferred to a reaction process chamber 2 where the substrate is subject to a predetermined processing as in the prior art. During the processing, control parameters such as specific resistance and temperature are controlled for set values determined by a processing recipe stored in a control computer 5. Alternatively, the control parameters are controlled automatically so as to match other control parameters with set values determined by a processing recipe. Data from sensors such as a specific resistance meter 3 and a thermometer 4 and the like are supplied to the control computer 5 via data paths 16. In a chemical cabinet 6, control parameters such as HNO₃ and HF flow rates similarly serve according to control instructions from the control computer 5. Meanwhile, data from sensors such as an HNO₃ flowmeter 7 and an HF flowmeter 8 and the like are supplied to the control computer 5. Here, control parameter data are collected by a data collection unit 12 of a monitoring system 10 in a specified sampling cycle and stored in a data storage unit 14.

A host computer 9 connected to the control computer 5 via a selector switch 11 gives instructions such as download of production step recipe names, wafer names, which are IDs unique to wafers, and lot names, substrate processing start, and end report.

Context parameters such as lot names, wafer names, and recipe names downloaded to the control computer 5 from the host computer 9 are collected by the data collection unit 12 of the monitoring system 10 and stored in the data storage unit 14 in the same manner as the control parameters.

Processing state parameters indicating the state and processing conditions of the substrate production apparatus such as recipe step numbers, processing states indicating in the operation mode or in the idle mode, chemical solution lifetime (operation time since the introduction of chemical solution) are also collected by the data collection unit 12 of the monitoring system 10 and stored in the data storage unit 14.

The substrate production apparatus 1 is different from the prior art in that it has a control state identification unit 15 identifying the control state of the substrate production apparatus including the subsidiary equipment based on the above data. The control state identification unit 15 identifies the control state based on the data stored in the data storage unit 14 and associates the identified control state with control parameters. The control parameters associated with the control state of the substrate production apparatus 1 are stored in the data storage unit 14. Then, a data evaluation unit 13 evaluates the control parameter values as to whether they are normal or abnormal in conjunction with the control state of the substrate production apparatus 1 or the subsidiary equipment such as the chemical cabinet 6.

When the data valuation unit 13 finds any abnormal control parameter value, the data evaluation unit 13 sends to the control computer 5 a stop instruction 17 to instruct the substrate production apparatus 1 to stop the processing.

Data from the sensors in the configuration of FIG. 1 may not be sufficient for evaluating the control state. In such a case, it is necessary to expand data by acquiring analog parameters such as control voltages of controlled parts provided in the subsidiary equipment in addition to the configuration shown in FIG. 1.

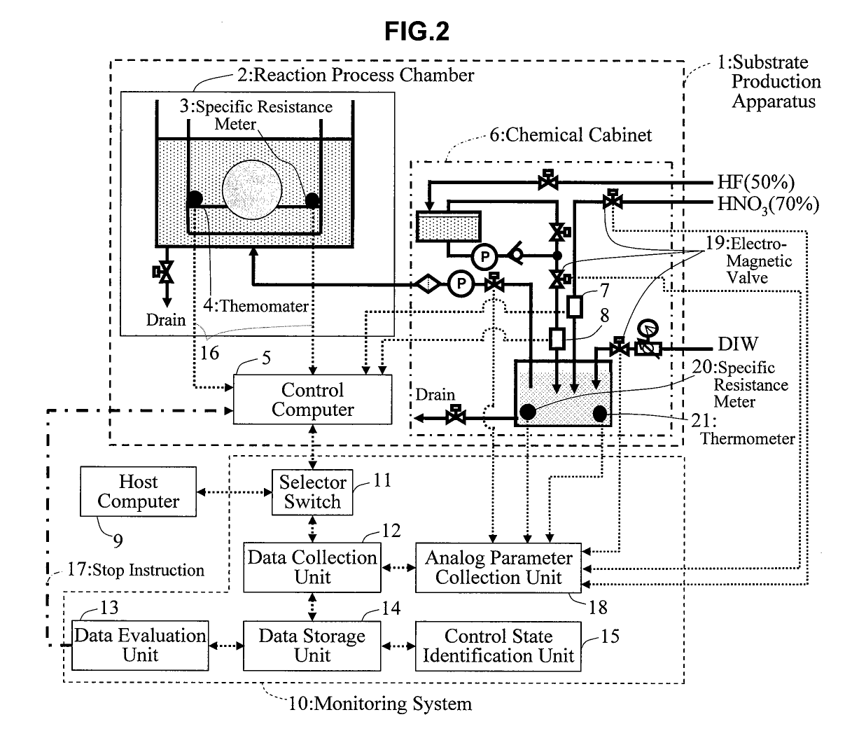

FIG. 2 shows a substrate production apparatus comprising an analog parameter collection unit obtaining analog parameters such as control voltages of the controlled parts provided in the subsidiary equipment and converting analog data to digital data in addition to the configuration shown in FIG. 1 in order to overcome the above problem. The same components as those explained above are not explained in detail in the following explanation.

In FIG. 2, an analog parameter collection unit 18 acquires the control voltages of electromagnetic valves 19 provided on the chemical solution lines of the subsidiary equipment. The control voltages are analog-to-digital converted at the analog parameter collection unit 18, whereby the chemical solution supplying state can be known. The analog parameter collection unit 18 can be realized as hardware as in this embodiment. The control voltages of the electromagnetic valves 19 are used to control the open/close of the valves. It can indirectly be known based on the control voltages whether the valves are opened or closed and therefore the chemical solution is supplied or not supplied. Then, it can obviously be known when the chemical solution is added to a chemical solution tank. The subsidiary equipment is found to be in the chemical solution supply state and the control state can further be classified. The analog parameter collection unit 18 similarly acquires the output voltages of a specific resistance meter 20 and a thermometer 21 provided in the chemical solution tank in which a chemical solution to be supplied to the reaction process chamber is accommodated in the chemical cabinet 6.

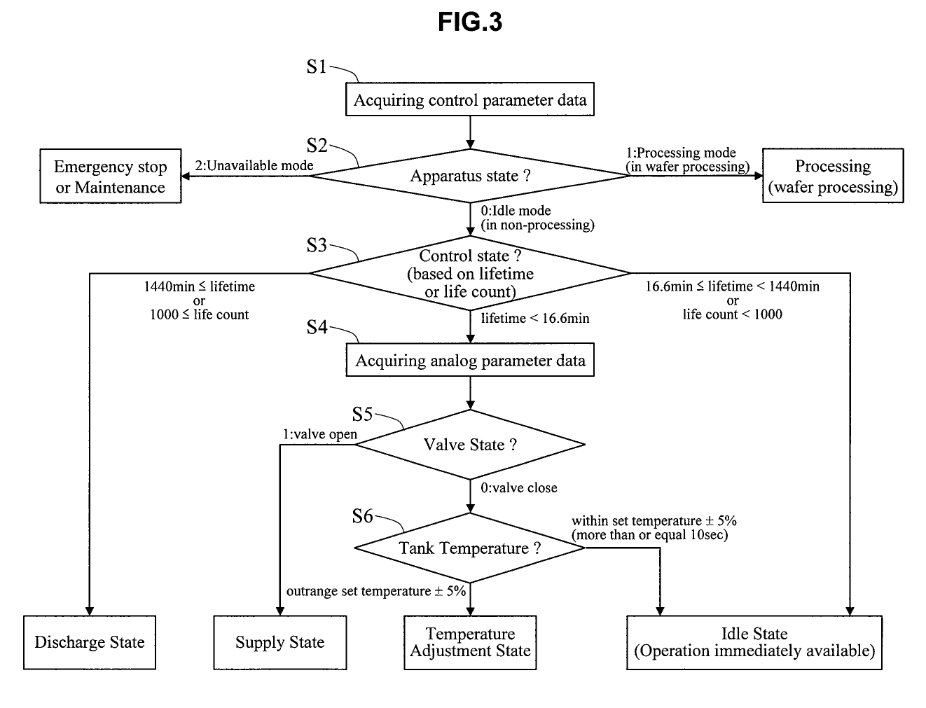

Identification of the control state of the chemical cabinet, which is the subsidiary equipment of the substrate production apparatus of this embodiment, will be explained hereafter with reference to the flowchart in FIG. 3.

In FIG. 3, first, the control state identification unit 15 acquires processing state parameter data necessary for identifying the control state from the date storage unit 14 and identifies the state of the substrate production apparatus 1 (Steps S1 and S2). In other words, the control state identification unit 15 determines whether the substrate processing apparatus 1 is in the substrate processing mode, in the non-processing mode, or unavailable because of apparatus maintenance service or emergency stop due to some errors. Here, the control state identification unit 15 assumes the idle mode when the obtained processing state parameter is “0,” the operation mode (wafer processing mode) when the obtained processing state parameter is “1,” or the unavailable mode when the obtained processing state parameter is “2.”

In the above identification, when the control state identification unit 15 determines that the substrate processing apparatus 1 is to be in the idle mode, the control state identification unit 15 further determines in which control state within the idle mode the substrate processing apparatus 1 is (Step S3). Here, the control state within the idle mode to be identified includes control states during the chemical solution replacement of the chemical cabinet 6 which is the subsidiary equipment. Here, the chemical solution replacement includes a discharge state in which the chemical solution in the chemical solution tank of the chemical cabinet is discharged, a supply state in which a chemical solution is supplied to the chemical solution tank after the discharge, and a temperature adjustment state in which the temperature of the supplied chemical solution is adjusted for some temperature according to the processing recipe.

In the substrate production apparatus 1, the chemical solution is replaced when a lifetime reaches 1440 minutes or when a life count reaches 1000, and when the apparatus is in the idle mode. Here, the lifetime is the elapsed time since the prior chemical solution replacement and the life count is the number of substrate processing operations since the prior chemical solution replacement. Therefore, the control state identification unit 15 identifies the control state of the chemical cabinet 6 based on the processing state parameter, the lifetime or the life count (Step S3). In Step S3, the control state identification unit 15 determines the discharge state when the substrate production apparatus 1 is not in the substrate processing mode and the above chemical solution replacement condition is satisfied. In this embodiment, although this is not restrictive, the lifetime or life count is reset after the discharge is completed. Furthermore, in this embodiment, the chemical solution is replaced when the lifetime reaches 1440 minutes or when the life count reaches 1000. These numbers are not fixed and vary depending on the setting of the substrate production apparatus. The thresholds of the lifetime and life count in Step S3 have to be changed according to the setting of the substrate production apparatus.

When the lifetime is less than 16.6 minutes, in other words when the elapsed time since the completion of discharge is less then 16.6 minutes in Step S3, the control state identification unit 15 acquires analog parameters from the data storage unit 14 and determines whether the chemical cabinet 6 is in the supply state or in the temperature adjustment state based on the analog parameters (Steps S4 and S5). When the electromagnetic valves 19 on the chemical solution lines of the subsidiary equipment are opened in Step S5, the control state identification unit 15 identifies that the control state in the idle mode is the chemical solution supply following the chemical solution discharge. Alternatively, when the lifetime is less than 16.6 minutes in Step S3, the electromagnetic valves 19 on the chemical solution lines of the subsidiary equipment are closed in Step S5, and the chemical solution temperature (tank temperature) outranges the set temperature±5% in Step S6, the control state identification unit 15 identifies that the control state in the idle mode is the temperature adjustment control. In the case of none of the above, the control state identification unit 15 identifies that the control state is the idle mode, but immediately available for the substrate processing.

The lifetime threshold is set for 16.6 minutes in Step S3 because the control up to the temperature adjustment since the chemical solution supply following the chemical solution discharge always takes place within 16.6 minutes if the substrate production apparatus including the subsidiary equipment of this embodiment is in the normal state. When the temperature adjustment is not completed more than 16.6 minutes after the chemical solution supply start, in other words when the tank temperature does not reach the set temperature±5% within 16.6 minutes in Step S6, some error occurs in the subsidiary equipment and all processes are subject to emergency stop in the substrate production apparatus 1. In Step S3, it is intended to identify a detailed control state while the substrate production apparatus 1 is available for normal operation and in the idle mode. Here, identification in a special shutdown state such as the above emergency stop and apparatus maintenance service is excluded. This is because such special shutdown state has already been found in the identification of the state of the substrate production apparatus 1 in Step S2.

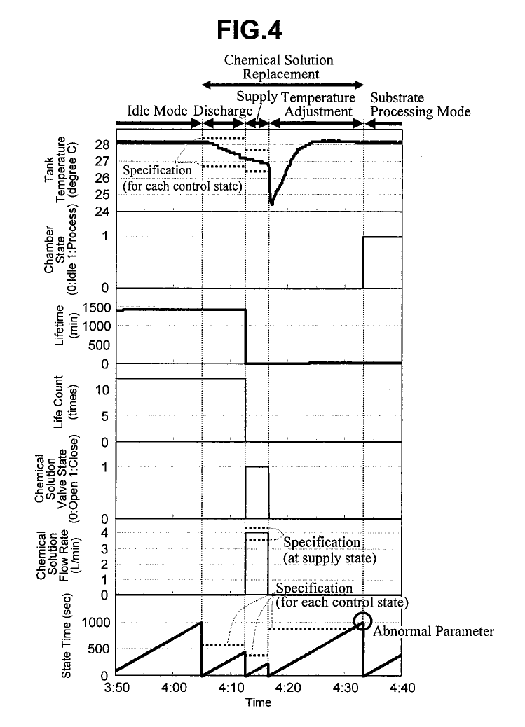

FIG. 4 shows control state identification results obtained by identifying the control state according to the flowchart in FIG. 3 and changes with time in the control parameters and processing state parameters. According to the flowchart in FIG. 3, the control states (chemical solution discharge, supply, and temperate adjustment) during the chemical solution replacement in FIG. 4 are identified and the control states of the subsidiary equipment can be known. The identified control state is associated with the obtained control parameters and stored in the data storage unit 14.

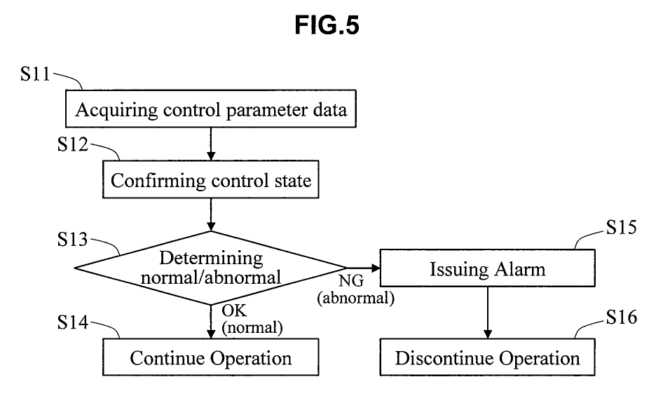

FIG. 5 is a flowchart for determining whether the substrate production apparatus 1 is abnormal/normal in this embodiment. Here, specification values of the control parameters are set for each control state during the idle mode specified in the flowchart in FIG. 3 and the identified, individual control state is evaluated as to whether it is abnormal/normal based on the specification values.

In FIG. 5, first, the data evaluation unit 13 acquires the control state and control parameters from the data storage unit 14 (Step S11). Then, the control state of the substrate production apparatus 1 and subsidiary equipment (the chemical cabinet 6) is confirmed based on the control state for the obtained control parameters and the individual control state is evaluated as to where the control parameter values are abnormal or normal based on the obtained control parameter values (Steps S12 and S13). When it is found to be normal, the substrate production apparatus 1 continues to operate (Step S14). When it is found to be abnormal, the apparatus issues an alarm and discontinues the operation (Steps S15 and S16). This series of flowchart can prevent the substrate production apparatus 1 from processing substrates in an abnormal state in advance, preventing reduction in the production yield.

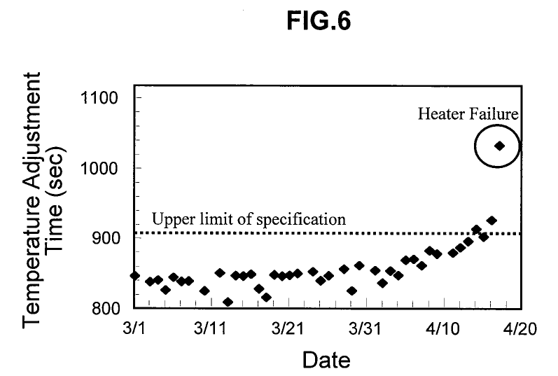

FIG. 6 shows the trend of temperature adjustment time during the chemical solution replacement in this embodiment.

FIG. 6 shows changes in the time required to raise the temperature during the chemical solution replacement, revealing that the time is gradually increased. This means that the heater used to raise the temperature during the chemical solution replacement gradually deteriorates in performance. The heater failed when the upper limit of monitored value was surpassed. As described above, by monitoring the control parameters for each control state or monitoring the transition of the elapsed time of a control state, any failure for example due to deterioration in some parts of the substrate production apparatus 1 can be detected in advance.

As described above, the present invention can easily identify the control state during the idle mode of the substrate production apparatus including a subsidiary equipment. The identified control state is associated with control parameters and specification values of the control parameters are set for each control state, whereby the individual control state during the idle mode is easily evaluated as to whether or not there is any abnormal event. Then, any abnormal event can be detected in the apparatus in the idle mode (prior to the start of substrate processing), preventing substrates from being processed in an abnormal state. Consequently, reduction in the production yield can be prevented.

The present invention is useful for and monitoring system of substrate production apparatuses included in production lines having high yields with nothing abnormal.

While the invention has been described in detail, the foregoing description is in all aspects illustrative and not restrictive. It is understood that numerous other modifications and variations can be devised without departing from the scope of the invention.

What is claimed is:

1. A monitoring system for a substrate production apparatus including a subsidiary equipment in which a predetermined reaction process takes place in a reaction chamber where a substrate is placed, comprising:
a data collection unit collecting control parameter data from the substrate production apparatus in a specific sampling cycle;
a data storage unit storing the control parameter data collected by the data collection unit;
a control state identification unit identifying control states in a substrate processing mode and in an idle mode within the substrate production apparatus including the subsidiary equipment based on the obtained control parameter data stored in the data storage unit; and
a data evaluation unit determining whether or not there is any abnormal event by evaluating the obtained control parameter data in the identified individual control state.

2. A monitoring system according to claim 1, further comprising an analog parameter collection unit obtaining an analog parameter including a control voltage of a controlled part provided in the subsidiary equipment and converting the obtained analog parameter data to digital data.

3. A monitoring method for a substrate production apparatus including a subsidiary equipment in which a predetermined reaction process takes place in a reaction chamber where a substrate is placed, comprising the steps of:
collecting control parameter data from the substrate production apparatus in a specific sampling cycle;
storing the control parameter data collected in the data collection step in a data storage unit;
identifying control states in a substrate processing mode and in an idle mode within the substrate production apparatus including the subsidiary equipment based on the obtained control parameter data stored in the data storage unit; and
determining whether or not there is any abnormal event by evaluating the obtained control parameter data in the identified individual control state.
